(19) United States
(12) Patent Application Publication
(10) Pub. No.: US 2004/0028409 A1
(43) Pub. Date: Feb. 12, 2004

(54) Method for transmitting security data in Ethernet passive optical network system

(76) Inventors: A-Jung Kim, Seoul (KR); Jin-Hee Kim, Suwon-shi (KR); Jae-Yeon Song, Songnam-shi (KR); Se-Youn Lim, Seoul (KR)

Correspondence Address: CHA & REITER, LLC, 210 ROUTE 4 EAST, PARAMUS, NJ, 07652, US

(21) Appl. No.: 10/634,700

(22) Filed: Aug. 5, 2003

(30) Foreign Application Priority Data
Aug. 7, 2002 (KR) 2002-46600

(51) Int. Cl. H04J 14/00

(52) U.S. Cl. 398/71

(57) ABSTRACT

A method for transmitting security data in an Ethernet PON (Passive Optical Network) system is provided. The method includes the steps of: a) creating a frame comprised of a data field for encrypting the security data, a key information field for storing key information used for decrypting the encrypted data of the data field, and a security frame, wherein the security frame includes an ONU ID (Identifier) field for indicating ONU ID information identified by an ONU having the destination user, and a user ID field for indicating a security ID identified by the destination user; and b) transmitting the created frame.

### CLAIM OF PRIORITY

This application claims priority to an application entitled “METHOD FOR TRANSMITTING SECURITY DATA IN ETHERNET PASSIVE OPTICAL NETWORK SYSTEM,” filed in the Korean Intellectual Property Office on Aug. 7, 2002 and assigned Ser. No. 2002-46600, the contents of which are hereby incorporated by reference.

### BACKGROUND OF THE INVENTION

1. Field of the Invention

The present invention relates to an Ethernet PON (Passive Optical Network) system, and more particularly to a method of transmitting security data in an Ethernet PON system.

2. Description of the Related Art

FIG. 1 is a network configuration of a conventional PON system, which includes a single OLT (Optical Line Termination) 100 and a plurality of ONUs (Optical Network Units) (110-1 to 110-3) connected to the OLT 100. As shown, FIG. 1 shows three ONUs 110-1, 110-2, and 110-3 connected to a single OLT 100 to which a plurality of end users 120-1, 120-2, and 120-3 may be connected. The OLT 100 is connected to the ONUs (110-1 to 110-3) over an ODN (Optical Distribution Network).

In operation, a plurality of data (131 to 133) transferred from the end users (120-1 to 120-3) is transmitted to the OLT 100 over the ONUs (110-1 to 110-3). The plurality of data transferred from the end users (120-1 to 120-3) is assigned different reference numbers (i.e., 131-1, 131-2, and 131-3) according to individual transmission intervals. However, if there is no need for the individual transmission intervals to be separated from each other, they are assigned with a single representative reference number. For example, the data (131-1 to 131-3) are called a single reference number “131”.

As shown in FIG. 1, the EPON (Ethernet Passive Optical Network) system for transmitting 802.3 Ethernet frames over a point-to-multipoint network adapts a TDM (Time Division Multiplexing) scheme to upstream transmission a “Broadcast and Selection” scheme to downstream transmission. In the case of the upstream transmission, a plurality of data of individual ONUs (110-1 to 110-3) is TDM-processed, and the TDM-processed data is transmitted to the OLT 100. In the case of the downstream transmission, the ONUs (110-1 to 110-3) receiving broadcast data from the OLT 100 selectively receive its assigned data.

However, the aforementioned operations have the following disadvantages.

Firstly, the EPON system is incompatible with the 802.1d standard, such that the ONUs 110-1 to 110-3 have no way to communicate with each other. In particular, the EPON system cannot communicate with other devices in a peer (i.e., the same hierarchy), such that the end users (120-1 to 120-3) connected to the ONUs (110-1 to 110-3) cannot communicate with one another. As such, the EPON system cannot perform peer-to-peer communication. This deficiency has been addressed by a point-to-point emulation scheme using an LLID (Logical Link ID). For example, the point-to-point emulation scheme using an LLID makes it possible to perform such peer-to-peer communication in the EPON system.

Secondly, the EPON system has inadequate security. For instance, if the OLT 100 transmits downstream messages to all ONUs (110-1 to 110-3), the EPON system selects the Broadcast and Selection scheme for allowing a corresponding ONU 110-1, 110-2, or 110-3 to filter/receive its own message. Although the ONUs (110-1 to 110-3) are unauthenticated during an upstream link, they can gain access to a network by unwanted party. For example, an ONU contained in the EPON system may disguise itself as other ONUs to gain access to data and source files. Therefore, there is a need to establish authentication procedures associated with individual ONUs to improve the security.

Encryption techniques for use in an ATM PON system have been standardized, and have been described in an ITU-T (International Telecommunication Union-T) G.983.1. However, an encryption function for use in an EPON system for transmitting Ethernet frames over a physical plant and a method for implementing the encryption function have not been prescribed in the ITU-T standards.

Therefore, there has been newly proposed a method for inserting an LLID into a preamble of an Ethernet frame to implement a point-to-point emulation using an LLID from an IEEE 802.3ah July meeting, such that the EPON system can perform peer-to-peer communication. If the preamble is encrypted or a tag associated with a security service is added to the frame, differentiated security services for every LLID become available.

However, as the above method requires a change of hardware, it is incompatible with a network having another topology. When a message is encrypted using an encryption algorithm while an encryption process is executed in an RS layer to perform a preamble process, a new encryption method for encrypting not only the message but also FCS (Frame Check Sequence) is needed to authenticate the message, resulting in a link management problem. More specifically, in the case where an FCS check error occurs in an erroneous noisy link, the proposed method for performing an encryption function in the RS layer cannot determine whether the FCS check error is caused by defects of a link or other devices or is caused by an unauthenticated message.

Further, the proposed method has a drawback in implementing a QoS (Quality of Service) or a SLA (Service level Agreement). In particular, when a plurality of LLIDs are assigned one ONU 110-1, 110-2, or 110-3 to perform either a service segregation operation or a traffic segregation operation, a high occupancy rate of a guard band is produced, thus resulting in not only ineffective link utilization, but also many problems in switching the ONUs 110-1 to 110-3 therebetween.

Even if a service segregation operation or a traffic segregation operation is performed by linking an LLID with a VLAN (Virtual LAN) technique, the magnitude of VLAN space is limited. Furthermore, if there are many VLANs supported by different service providers, no interoperability among the VLANs exists in a method of supporting no compartment among the VLANs, thereby resulting in difficulty in executing the service or traffic segregation on a single physical topology.

### SUMMARY OF THE INVENTION

Therefore, the present invention has been made to overcome the above problems and provides additional advantages, by providing a method for increasing a security level when transmitting data in an EPON system.

It is one aspect of the present invention to provide a data transmission method for solving incompatibility with an IEEE 802.1d protocol and establishing user-to-user communication.

It is yet another aspect of the present invention to provide a security communication method for an EPON system which performs an encryption process to solve a security problem created in a point-to-multipoint EPON configuration.

In one embodiment, a method for transmitting security data between an OLT (Optical Line Termination) and a destination user in an EPON (Ethernet Passive Optical Network) system is provided. The method includes the steps of: a) creating a transmission frame comprised of a data field for encrypting the security data, a key information field for storing key information used for decrypting the encrypted data of the data field, and a security frame, wherein the security frame includes an ONU ID (Identifier) field for indicating ONU ID information identified by an ONU having the destination user, and a user ID field for indicating a security ID identified by the destination user; and b) transmitting the created transmission frame.

Further, the present invention creates signal processing fundamentals compatible with a variety of physical environments or topologies that are independent of a physical layer in an EPON system, such that security communication can be performed due to the created signal processing fundamentals. To this end, the present invention adapts a virtual group ID to extend the magnitude of VLAN space and creates interoperability among VLANs. Further, the present invention provides a service segregation service, a traffic segregation service, and a transfer rate limitation service, and configures the implemented services in the form of a private link.

### BRIEF DESCRIPTION OF THE DRAWINGS

The above features and other advantages of the present invention will be more clearly understood from the following detailed description taken in conjunction with the accompanying drawings, in which:

FIG. 1 is a view illustrating a physical configuration for a conventional PON system;

FIG. 2 shows a message format of an EPON Ethernet frame in accordance with a preferred embodiment of the present invention;

FIG. 3 illustrates a clear PON tag header format in accordance with a preferred embodiment of the present invention;

FIG. 4 illustrates an EPON protocol stack in accordance with a preferred embodiment of the present invention; and

FIG. 5 illustrates an encryption layer contained in the EPON protocol stack in accordance with a preferred embodiment of the present invention.

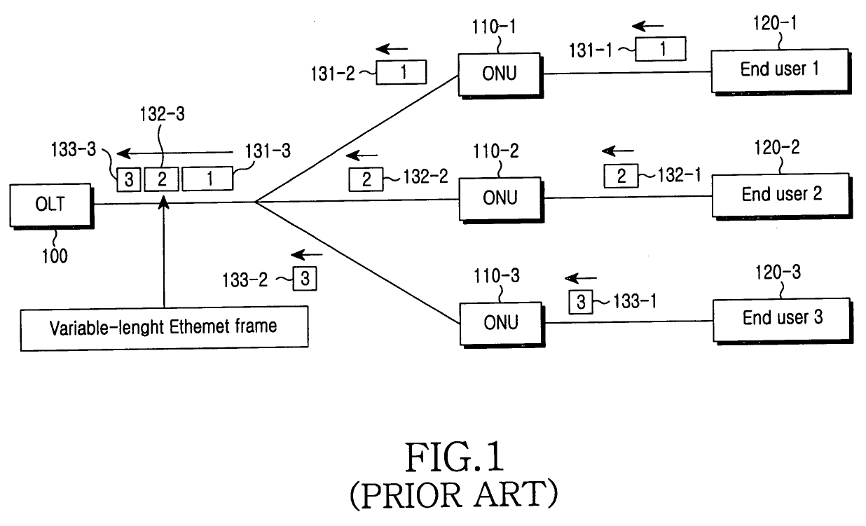

### DETAILED DESCRIPTION OF THE PREFERRED EMBODIMENTS

Now, preferred embodiments of the present invention will be described in detail with reference to the annexed drawings. For the purposes of clarity and simplicity, a detailed description of known functions and configurations incorporated herein will be omitted as it may make the subject matter of the present invention unclear.

In order to not only create a logical link using point-to-point emulation but to create a logical link in the form of an exclusive private link in a point-to-multipoint EPON system, which is comprised of a single OLT 100 and a plurality of ONUs 110-1 to 110-3 connected to the OLT 100, the present invention adapts individual logical links as granularity of a security service to encrypt the logical links, such that the system allows the transmission of confidential data. Further, the present invention implements logical virtual LAN topology in a physical network using a VLAN technique and further provides basic a QoS (Quality of Service) and a SLA (Service level Agreement).

According to the teachings of the present invention, an LLID (Logical Link ID)for use in point-to-point emulation is inserted into an Ethernet frame. To assign a group ID to several VLANs using the LLID and to perform a rate limiting function and a service segregation function using the LLID, the present invention provides an encryption operation by considering the LLID to be a combination of VLANs or similar Ids, then performs an encryption operation. Further, the present invention provides a mechanism to insert either a predetermined field for checking data integrity or a predetermined field for checking data origin integrity into the Ethernet frame, then encrypts the fields along with a predetermined message.

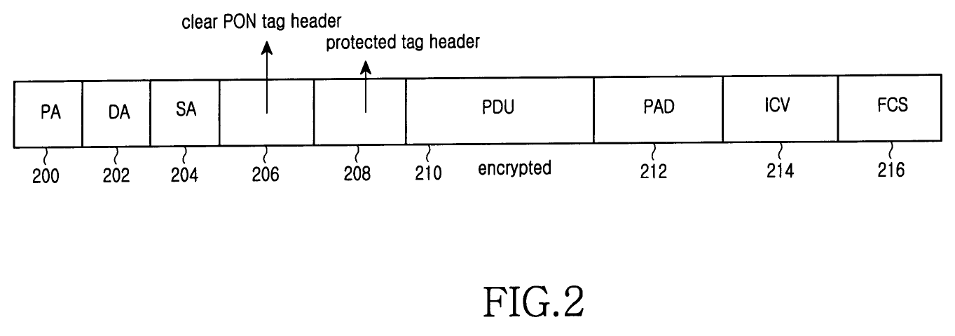

FIG. 2 illustrates a message format of an EPON Ethernet frame in accordance with a preferred embodiment of the present invention.

As shown in FIG. 2, an Ethernet message frame according to the present invention includes a PA (PreAmble) field 200, a DA (Destination Address) field 202, a SA (Source Address) field 204, a clear PON tag header field 206, a protected tag header field 208, a PDU field 210, a PAD field 212, an ICV (Integrity Check Value) 214, and a FCS (Frame Check Sequence) field 216.

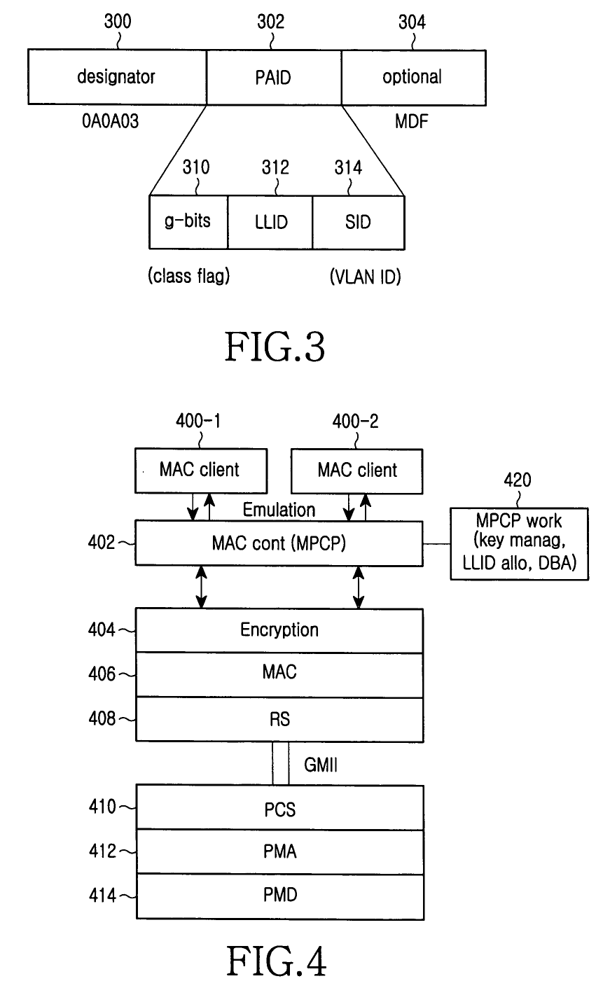

The clear PON tag header field 206 functions as a security frame and indicates transmission of security data. The clear PON tag header field 206 will be described later with reference to FIG. 3. The protected tag header field 208 is an optional field and functions as an encryption field. The protected tag header field 208 is used to transmit various optional information associated with a data originating station, for example, integrity check information, security label information, fragment ID information, and flag information, etc.

The PAD field 212 is an optional field. Provided that a confidentiality algorithm or an integrity algorithm used in a system need data of a prescribed length, the PAD field 212 may be added to the Ethernet message frame according to the data length. In the embodiment, there is no need for the PAD field 212 to use a mechanism for maintaining a prescribed packet length, for example, an OCB(Offset Code Back) mode, and a CSR (Counter) mode, etc. of cryptology. In the case of an algorithm for requiring a padding process, a prescribed field for indicating a pad length must be added to the last area of the pad field 212.

The ICV field 214 is adapted to check message integrity. For example, if an OCB mode using an AES (Advanced Encryption Standard) is adapted as an encryption algorithm, the ICV field 214 has a predetermined check sum of either 4 bytes or 10 bytes. The range of the integrity check may also be applied to even a protected tag header field 208, a PDU (Packet Data Unit) field 210, and a PAD field 212.

FIG. 3 is a view illustrating a detailed configuration of the clear PON tag header field 206 contained in the Ethernet message frame format shown in FIG. 2 in accordance with a preferred embodiment of the present invention.

As shown in FIG. 3, the clear PON tag header 206 used for a security purpose includes a designator 300 for indicating the Ethernet frame serving as a particular tagged frame, a PAID (PON Association ID) field 302, and an optional field 304. The MDF (Management Defined Field) serving as an optional field 304 is shown in FIG. 3.

In operation, the designator 300 can be set to a prescribed value ‘0A0A03’ by concatenating a hexadecimal value ‘oa0A0A’ being a redundant LSAP (Link Service Access Point) of 2 bytes and an UIC (Unnumbered Information Control) value ‘ox03’ of 1 byte, such that it can be compatible with the IEEE 802.10.

The PAID field 302 includes identifiers (IDs) for identifying individual ONUs (110-1 to 110-3) to perform peer-to-peer communication. The IDs classify services associated with the ONUs (110-1 to 110-3) into services for every user group in order to perform a service segregation function or a traffic segregation function. Here, the IDs may be assigned different keys, respectively, such that it can be considered to be an entity object needed for performing a security service.

The PAID field 302 further includes an LLID field 312 for identifying the ONUs (110-1 to 110-3) or management entities, such as different service providers, and an SID (Security ID) field 314 for adapting the LLID field 312 as a group ID to create a plurality of entities controlled by a single ONU 110-1, 110-2, or 110-3. Here, a variety of classes are provided according to the total number of the SIDs controlled by the management entity, and the number of LLID fields 312 and the number of SID fields 314 can be limited in the classes. It is preferable that a 3-bit group bit 310 having a prescribed value ‘101’ adapts the LLID field 312 of 17 bits and the SID field 314 of 12 bits to establish compatibility with the IEEE 802.10. In this case, an LLID field 312 may be comprised of a mode bit of 1 bit for indicating a broadcast/unicast mode, and a real LLID 312 of 16 bits. The SID field 314 corresponds to a VLAN ID in the case of using a conventional VLAN technique.

I the embodiment, a combination of 65,536 numbers of different ONUs 110-1 to 110-3 and a manager can support 4096 number of different VLANs. Provided that a destination is a multicast group ID, the PAID field 302 may be set to a common value of all users contained in a corresponding group. In more detail, the management entity allocates a single multicast group PAID to a multicast group address, and a prescribed key is assigned members of the group to perform a security service in such a way that multicast data can be managed and controlled.

Finally, the MDF (Management Defined Field) 304 is an optional field to store various MIB (Management Information Base)—associated information or protocol information associated with the MIB information.

As illustrated above, the present invention creates a security data transmission frame shown in FIGS. 2 and 3, and transmits the created frame in such a way that security data can be transmitted over the EPON.

FIG. 4 is a view illustrating an EPON protocol stack in accordance with a preferred embodiment of the present invention. In particular, FIG. 4 shows a layered configuration displayed in the form of a protocol stack to perform a security communication function in the EPON system. As shown, the EPON protocol stack includes a plurality of MAC (Media Access Control) client layers 400-1 and 400-2, a MPCP (Multi-Point Control Protocol or MAC control) layer 402, a MPCP work layer 420 for performing a variety of MAC control functions such as key management, LLID allocation, and DB management, etc., an encryption layer 404, a MAC layer 406, an RS layer 408, a PCS layer 410, a PMA layer 412, and a PMD layer 414. The security data transmission frame shown in FIGS. 2 and 3 is created from the encryption layer 404.

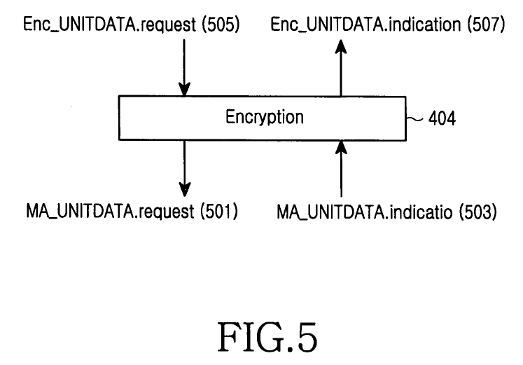

FIG. 5 is a view illustrating an encryption layer contained in the EPON protocol stack in accordance with a preferred embodiment of the present invention. In particular FIG. 5 shows a detailed diagram of a primitive of the encryption layer 404 contained in the EPON protocol stack shown in FIG. 4.

Referring back to FIGS. 3 and 5, a plurality of PAID fields 302 are adapted to identify entities for performing service/traffic segregations and may indicate entities assigned with different keys. Alternatively, the PAID fields 302 allocate different keys to group IDs for every ONU and may perform the service/traffic segregation for every SID.

If there is no security service, a prescribed value for indicating an IEEE 802.10 VLAM frame is recorded in the designator field 300, then a real VLAN ID is recorded in the SID field 314 contained in the PAID field 302. As such, VLAN spaces for every service provider or every ONU can be extensively created without using an overhead associated with an encryption process, thus avoiding any limitations in a QoS, a SLA, and a transfer rate.

Note that encryption information for indicating encryption completion or unused encryption may change an RTT (Round Trip Time), which is consumed during a round trip of a real packet due to an encryption processing time. Therefore, it is preferable for an encryption engine to perform a parallel processing such that a processing time is consumed irrespective of a packet length. The same delay time as the encryption process must be created to guarantee a fixed RTT even in the case of an encryption-disabled packet.

In the case of supporting a security service, a transmitted message is triggered at the MAC clients 400-1 and 400-2 and is then transmitted to the encryption layer 404. In this case, the clear tag header 206 is inserted from the MAC upper layer 402 to the encryption layer 404. Thereafter, as shown in FIG. 5, a plurality of messages such as a DA message, a SA message, an m_sdu message, etc. are transmitted to the encryption layer 404. The protected tag header field 208 and the pad field 212 associated with a security mechanism are inserted into the encryption layer 404 according to the encryption information. The encryption layer 404 contains an integrity check field for performing an integrity check operation and encrypts the protected tag header field 208, the PAD field 212, the fault check field, and the ICV field 214 along with their messages. That is, the encryption fields of the Ethernet frame ranges from the protected tag header field 208 to the ICV field 214.

The MA_UNIDATA.request field 501 is equal to an Ethernet frame other than the FCS field 216 in an Ethernet message frame format defined in FIG. 2.

For error correction, the FCS field 216 for checking whether a physical error occurs in a MAC frame having encrypted data is added to the MAC layer 406. The MAC layer 406 performs an FCS check operation on the received message in association with all the Ethernet frame fields (DA˜ICV) 202 to 214 having encrypted data of Ethernet frames transferred to the MAC layer 406. The MAC layer 406 receiving the Ethernet frame using the above method compares its own FCS result value with a value of the FCS field 216 contained in the received Ethernet frame, and then transmits the resultant value to the upper layer as a Receive_Status signal. In this case, the MAC layer 406 removes the FCS field 216 from the Ethernet frame. Thereafter, a decryption process and an integrity check process are sequentially performed and their result values are compared with a value of the ICV field 214. If the result values are different from the value of the ICV field 214, information indicating such information is recorded in a message integrity break count field.

Provided that the FCS check procedure is performed completely as a check sum of the encryption field is equal to the FCS value and the FCS, this condition indicates that there is no error due to faults of a link or process. Meanwhile, if a check sum of the ICV field decrypted by a decryption process is equal to a value of the ICV field, this condition indicates that the check sum value is encrypted using a correct key, such that it can be recognized that a message has integrity. Therefore, the FCS check is adapted to check an error of a link or a process, and the ICV check is adapted to check integrity of either a message contained in an Ethernet frame or a message source.

Therefore, the PAD field 212, the encryption tag, and the ICV field 214 are removed to prevent unnecessary data transmission to MPCP, and the present invention transmits the clear tag header field 206 containing the PAID field 302, the PDU field 210, the DA field 202, the SA field 204 to the MAC clients 400-1 and 400-2.

As apparent from the above description, the present invention inserts an LLID field 312 serving as a logical link into the Ethernet message frame and transmits the Ethernet message frame having the LLID field 312, thereby implementing a PHY (PHYsical layer)—independent technique. Therefore, the present invention can be compatible with various physical environments associated with other physical layers and network topology. In addition, because a group ID is assigned the LLID field 312 in association with individual ONUs (110-1 to 110-3) or service providers, the magnitude of VLAN space is extended and interoperability among VLANs is implemented. As a result, the present invention can implement service segregation, traffic segregation, and transfer rate limitation services using the PAID field 302 if needed. Furthermore, the present invention performs key management services for every LLID field 312 or every PAID field 302, such that security services associated with data integrity, data source integrity, and confidentiality are available.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for transmitting security data between an OLT (Optical Line Termination) and a destination user in an EPON (Ethernet Passive Optical Network) system having a plurality of ONUs (Optical Network Units) connected to a plurality of users and the OLT the methodcomprising the steps of:
a) creating a transmission frame comprised of a data field for encrypting the security data, a key information field for storing key information used for decrypting the encrypted data of the data field, and a security frame having an ONU ID field for indicating ONU ID information identified by an ONU with the destination user and a user ID field for indicating a security ID identified by the destination user; and
b) transmitting the transmission frame.

2. The method as set forth in claim 1, wherein the security frame further includes a designator field for storing information of a group of the ONUs and the users.

3. The method as set forth in claim 1, wherein the security frame further includes a MDF (Management Defined Field) for storing MIB (Management Information Base) information and associated protocol information.

4. The method as set forth in claim 1, further comprising the step of:
c) transmitting the transmission frame to the users connected to the ONUs for identifying the ONU ID field contained in the security frame of the transmitted frame.

5. The method as set forth in claim 1, further comprising the steps of:
selecting at least one user who can identify contents of the ONU ID field contained in the security frame from among the plurality of users connected to the ONUs for identifying the ONU ID field, and transmitting the transmission frame to the selected user.
